(19) United States
(12) Patent Application Publication
(10) Pub. No.: US 2010/0246700 A1
(43) Pub. Date: Sep. 30, 2010

(54) CONVERTER

(75) Inventor: Shinsuke Moriai, Gifu (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/738,624

(22) PCT Filed: Oct. 20, 2008
(86) PCT No.: PCT/JP2008/002963

§ 371 Date: Jun. 9, 2010

(30) Foreign Application Priority Data
Oct. 19, 2007 (JP) 2007-272136

(51) Int. Cl. H04L 27/28

(52) U.S. Cl. 375/260; 375/295

(57) ABSTRACT

A bit-converting unit inputs from an FFT unit a multicarrier signal converted into the frequency domain and shown as a floating-point number. The bit-converting unit specifies the position of the highest-order bit for each of a plurality of subcarriers that form the multicarrier signal and determines the position of a bit width to be commonly used for each of the plurality of subcarriers based on the specified position of the highest-order bit. The bit-converting unit converts the multicarrier signal from a floating-point number to a fixed-point number while using the determined position of the bit width. The bit-converting unit outputs the converted multicarrier signal to a reception processor that performs fixed-point arithmetic.

### TECHNICAL FIELD

The present invention relates to conversion techniques and particularly to a converter that converts floating-point numbers into fixed-point numbers.

### BACKGROUND ART

In digital signal processing, point numbers are represented by floating-point numbers or fixed-point numbers.

In the representation by fixed-point numbers, the bit number used for the integer part and the bit number used for the fractional part are fixed in advance. Of the four arithmetic operations involved in fixed-point arithmetic, addition and subtraction are considered to be the addition and subtraction of integers. On the other hand, the value of a floating-point number is represented by the following three data parts. The first is the sign, the value of one bit. The second is the significand, an unsigned integer, and the third is the signed integer exponent. In floating-point numbers, the absolute values of numerical numbers are represented as follows.
significand×base^{exponent}

The range of values that can be expressed by fixed-point numbers is much smaller than that which can be expressed by floating-point numbers. However, in fixed-point numbers, there is no loss of information, and operations are carried out at high speed. On the other hand, although the range of values that can be expressed by floating-point numbers is larger, the operation speed of floating-point arithmetic is slower than that of fixed-point arithmetic (for example, see patent document 1).

[Patent document No. 1] Japanese Patent Application Laid-open 2002-288151

### DISCLOSURE OF THE INVENTION

### Problem to be Solved by the Invention

In recent years, an OFDM (Orthogonal Frequency Division Multiplexing) modulation scheme is used so as to increase the transmission speed in a wireless communication system. An OFDMA (Orthogonal Frequency Division Multiple Access) scheme, which is an access scheme using an OFDM modulation scheme, is also used. In such an OFDM modulation scheme and OFDMA scheme, an IFFT (Inverse Fast Fourier Transform) is used on the transmitting side and an FFT (Fast Fourier Transform) is used on the receiving side. The number of bits (hereinafter, also referred to as the “bit width”) that can be used is limited. Thus, in order to expand the range of values that can be expressed, for example, the FFT uses floating-point arithmetic. On the other hand, since the signal processing of a signal on which FFT is carried out requires high-speed processing, the signal processing uses fixed-point arithmetic. Under such circumstances, conversion from floating-point numbers into fixed-point numbers is carried out before the signal processing and after the FFT processing.

When a base station apparatus adaptable for OFDMA transmits a signal, the number of subcarriers used greatly varies depending on the status of assignment of channels to terminal apparatuses. The smaller the number of subcarriers used, the smaller the amplitude of a signal, after an IFFT is carried out, becomes. The larger the number of subcarriers used, the larger the amplitude of a signal, after an IFFT is carried out, becomes. For convenience sake, the former is referred to as a first case and the latter is referred to as a second case. A terminal apparatus carries out an FFT after adjusting the reception level at AGC. Regardless of whether it is the first case or the second case, the amplitude of a received signal is made equal by the AGC. Therefore, the amplitude of each subcarrier signal becomes larger in the first case as compared to the second case, after the FFT.

The conversion from a floating-point number into a fixed-point number corresponds to cutting out a value, which is shown in the floating-point number by a bit width placed at a fixed bit position. If the position of the bit width is not appropriate, an overflow or underflow occurs. The position of the bit width suitable for the first case and the position of the bit width suitable for the second case differ greatly from each other. Therefore, it is necessary to adjust the position of the bit width so as to be suitable for both cases.

In this background, a purpose of the present invention is to provide technology for adjusting the position of bit width when performing the conversion of a multicarrier signal from a floating-point number into a fixed-point number, in accordance with the value of the signal.

### Means for Solving the Problem

A converter according to one embodiment of the present invention comprises: an input unit operative to input a multicarrier signal that has been converted into the frequency domain and that is also a multicarrier signal shown as a floating-point number; a converting unit operative to perform conversion from a floating-point number to a fixed-point number on the multicarrier signal input by the input unit; and an output unit operative to output the multicarrier signal converted by the converting unit to a signal processor that performs fixed-point arithmetic. The converting unit includes: a specification unit operative to specify the position of the highest-order bit for each of the plurality of subcarriers that form the multicarrier signal; a determination unit operative to determine the position of a bit width to be commonly used for each of the plurality of subcarriers based on the position of the highest-order bit specified by the specification unit; and a processing unit operative to convert the multicarrier signal while using the position of the bit width determined by the determination unit.

Optional combinations of the aforementioned constituting elements, and implementations of the invention in the form of methods, apparatuses, systems, recording mediums, and computer programs may also be practiced as additional modes of the present invention.

### ADVANTAGEOUS EFFECTS

According to the present invention, the position of the bit width can be adjusted when performing the conversion of a multicarrier signal from a floating-point number into a fixed-point number, in accordance with the value of the signal.

### BRIEF DESCRIPTION OF DRAWINGS

FIG. 1 is a diagram illustrating the configuration of a communication system according to an embodiment of the present invention;

FIG. 2A is a diagram illustrating a frame configuration in the communication system of FIG. 1;

FIG. 2B is a diagram illustrating a frame configuration in the communication system of FIG. 1;

FIG. 2C is a diagram illustrating a frame configuration in the communication system of FIG. 1;

FIG. 3 is a diagram illustrating the arrangement of subchannels in the communication system of FIG. 1;

FIG. 4 is a diagram illustrating the configurations of an FFT unit, a bit-converting unit, and an IQ shift unit of FIG. 1; and

FIG. 5 is a diagram illustrating the overview of the processes of an FFT unit and a bit-converting unit of FIG. 4.

[EXPLANATION OF REFERENCE]

| | |
|---|---|
| 10 | base station apparatus |
| 12 | modulator |
| 14 | IFFT unit |
| 16 | RF unit |
| 18 | antenna for a base station |
| 20 | terminal apparatus |
| 22 | antenna for a terminal |
| 24 | frequency-converting unit |
| 26 | AGC |
| 28 | A/D unit |
| 30 | filter unit |
| 32 | FFT unit |
| 34 | bit-converting unit |
| 36 | IQ shift unit |
| 38 | reception processor |
| 40 | control unit |
| 50 | coefficient memory unit |
| 52 | multiplier |
| 54 | accumulator |
| 56 | 16-bit cut-out unit |
| 100 | communication system |

### BEST MODE FOR CARRYING OUT THE INVENTION

A brief description is now given before focusing on specific features of the present invention. Embodiments of the present invention relate to a communication system comprised of a base station apparatus and at least one terminal apparatus. In a communication system, frames are formed by time-division multiplexing a plurality of time slots, and time slots are formed by frequency-division multiplexing a plurality of subchannels. Subchannels are formed by multicarrier signals. In this case, an OFDM signal is used as a multicarrier signal, and an OFDMA scheme is used for frequency division multiplexing. The base station apparatus communicates with a plurality of terminal apparatuses by assigning a plurality of subchannels included in each time slot to respective terminal apparatuses (hereinafter, the unit specified by a time slot and a subchannel is referred to as a “burst”).

In order to clarify the explanation, a downlink from a base station apparatus to a terminal apparatus is to be explained in the following. Thus, the base station apparatus corresponds to a transmission apparatus and the terminal apparatus corresponds to a reception apparatus. The base station apparatus may use a few subchannels or may use many subchannels at the time of transmission. In other words, the first case and the second case, which have been described previously, also exist in the embodiment. When the receiving function of a terminal apparatus is configured as described previously, it is necessary to adjust the position of the bit width so as to be suitable for both the first case and the second case. In order to deal with this, the terminal apparatus according to the present embodiment carries out the following process.

The terminal apparatus carries out an FFT by use of floating-point arithmetic. Thus, a signal that corresponds to each subcarrier is shown by a floating-point number. It is assumed that the bit number of the floating-point number is larger than the bit number of the fixed-point number, which will be created after the conversion. For example, the former is 48 bits and the latter is 16 bits. In other words, in order to improve the processing accuracy, the bit number is designed so that the bit number during the first part of a process is larger than the bit number during the last part of the process. The terminal apparatus specifies the position of the highest-order bit of a signal represented by 48 bits that indicates an effective value and extracts the value of 16 bits, having the specified bit as a first bit. In general, the value of a signal varies for each subcarrier. Thus, the position of the 16 bits that are extracted also varies. In a subsequent stage, a reception process is performed on the value of a fixed-point number. It is preferable that the position of the bit width is common for all subcarriers at that time. Thus, the terminal apparatus specifies the position of the bit having the greatest value among the highest-order bits of the subcarriers and specifies, as the position of the bit width, the position of the 16 bits having the specified bit as a first bit.

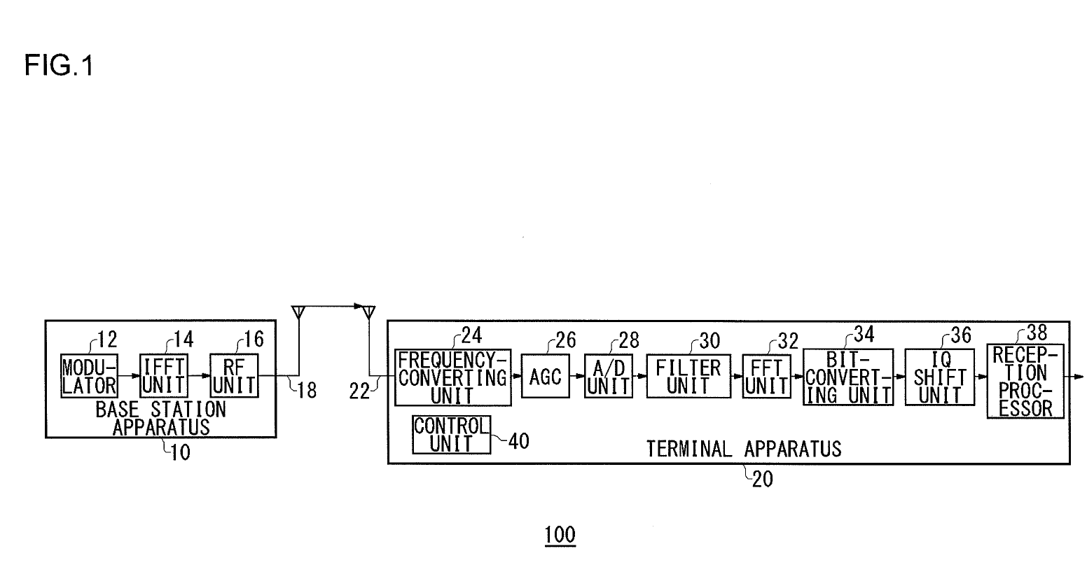

FIG. 1 shows the configuration of a communication system 100 according to the embodiment of the present invention. The communication system 100 includes a base station apparatus 10 and a terminal apparatus 20. The base station apparatus 10 includes a modulator 12, an IFFT unit 14, an RF unit 16, and an antenna for a base station 18, and the terminal apparatus 20 includes an antenna 22 for a terminal, a frequency-converting unit 24, an AGC 26, an A/D unit 28, a filter unit 30, an FFT unit 32, a bit-converting unit 34, an IQ shift unit 36, a reception processor 38, and a control unit 40.

The base station apparatus 10 connects, at one end, to the terminal apparatus 20 via a wireless network and connects, at the other end, to a wired network (not shown). The terminal apparatus 20 connects to the base station apparatus 10 via the wireless network. Having a plurality of time slots and a plurality of subchannels, the base station apparatus 10 performs an OFDMA by use of the plurality of subchannels while performing a TDMA by use of the plurality of time slots. As previously described, a unit represented by the combination of a time slot and a subchannel is defined as a burst. By allocating bursts to a plurality of terminal apparatuses 20, respectively, the base station apparatus 10 communicates with the plurality of terminal apparatuses 20. More specifically, the base station apparatus 10 specifies any one of the plurality of subchannels to be a control channel. The base station apparatus 10 transmits a broadcast signal, such as a BCCH, via the control channel on a regular basis.

The terminal apparatus 20 recognizes the existence of the base station apparatus 10 by receiving the BCCH and requests ranging from the base station apparatus 10. The base station apparatus 10 responds to the ranging. Ranging is a process used for correcting the frequency offset and timing offset of the terminal apparatus 20. However, a publicly-known technique needs to be used for ranging, and the explanation thereof is thus omitted. The terminal apparatus 20 then transmits a request signal requesting burst assignment from the base station apparatus 10, and the base station apparatus 10 assigns a burst to the terminal apparatus 20 in response to the received request signal.

The base station apparatus 10 transmits information regarding the burst assigned to the terminal apparatus 20, and the terminal apparatus 20 communicates with the base station apparatus 10 while using the assigned burst. As a result, the data transmitted from the terminal apparatus 20 is output to a wired network via the base station apparatus 10 and eventually received by a communication apparatus (not shown), which is connected to the wired network. The data is also transmitted in a direction from the communication apparatus to the terminal apparatus 20. As previously described, a detailed description will be made mainly regarding the downlink data transmission from the base station apparatus 10 to the terminal apparatus 20. A detailed description is now given of the format of a signal between the base station apparatus 10 and the terminal apparatus 20 before an explanation is given of the configurations of the base station apparatus 10 and the terminal apparatus 20.

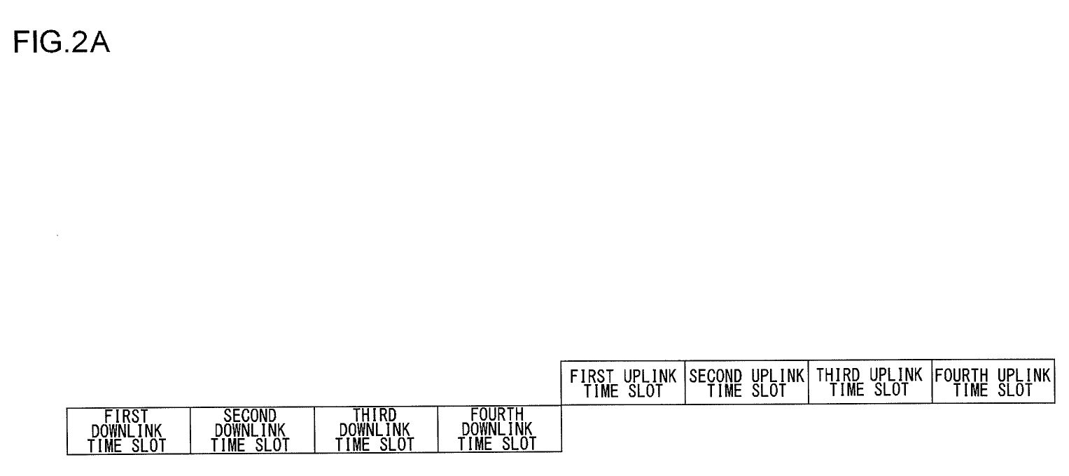

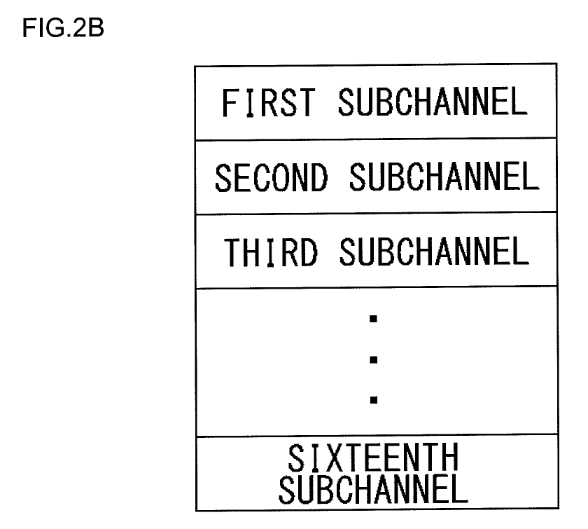

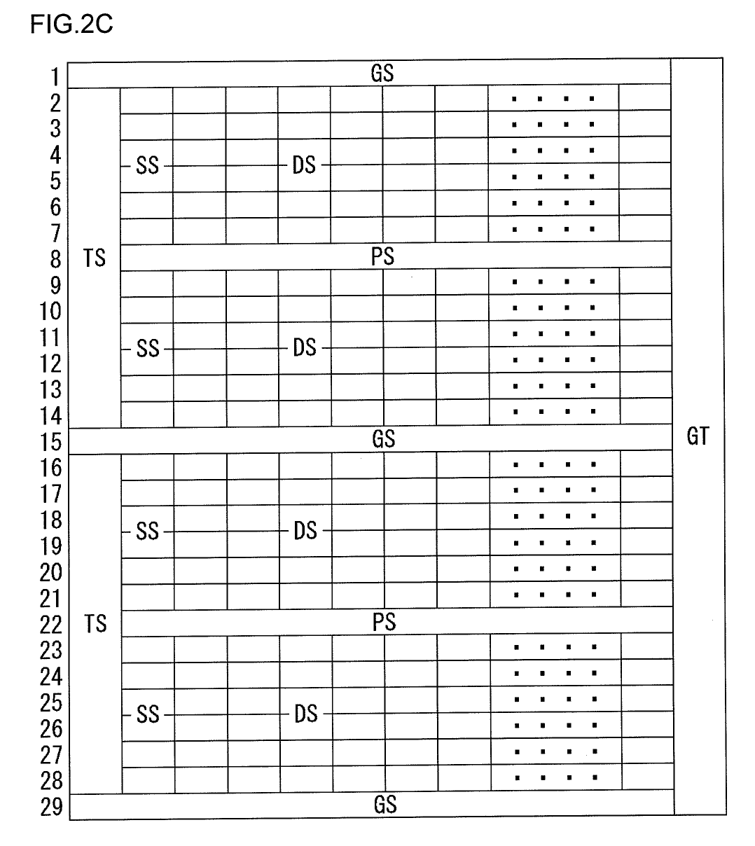

FIGS. 2A-2C illustrate frame configurations in the communication system 100. The horizontal direction of the figure represents a time axis. The frames are formed by the time division multiplexing of eight time slots. The eight time slots are constituted by four downlink time slots and four uplink time slots. The four downlink time slots are shown as a “first downlink time slot” through a “fourth downlink time slot,” and the four uplink time slots are shown as a “first uplink time slot” through a “fourth uplink time slot.” The frames that are illustrated are continuously repeated. The frame configuration is not limited to FIG. 2A. For example, the frames may comprise four time slots or sixteen time slots. However, in order to clarify the explanation, the explanation is given based on the assumption that the configuration of the frames is as shown in FIG. 2A.

In order to simplify the explanation, it is assumed that the configuration of the downlink time slot and the configuration of the uplink time slot are identical. Thus, even when only an explanation is given of either the downlink time slot or the uplink time slot, a similar explanation is valid for the time slot of which the explanation is not given. Furthermore, a superframe is formed by a plurality of successive frames shown in FIG. 2A. As an example, it is assumed that a superframe is formed by “20” frames in the following.

FIG. 2B illustrates the configuration of one of the time slots shown in FIG. 2A. The vertical direction of the figure represents a frequency axis. As shown in the figure, one time slot is formed by the frequency multiplexing of “16” subchannels, from a “first subchannel” to a “sixteenth subchannel.” Since the time slots are configured as shown in FIG. 2B, the previously-mentioned communication channel can be specified by the combination of a time slot and a subchannel. A frame configuration corresponding to one of the subchannels of FIG. 2B may be determined to be the frame configuration of FIG. 2A. The number of subchannels arranged for one time slot may not be “16”. The allocation of subchannels in an uplink time slot and the allocation of subchannels in a downlink time slot are assumed to be identical. It is assumed that at least one control signal is allocated in each unit of a superframe. For example, a control signal is allocated to one subchannel of one time slot among the plurality of downlink time slots included in a superframe. It is also assumed that the subchannel to which the control signal is allocated is specified in advance, for example, to be a first subchannel.

FIG. 2C illustrates the configuration of one of the subchannels of FIG. 2B. Similar to FIGS. 2A and 2B, the horizontal direction and the vertical direction of the figure represent a time axis and a frequency axis, respectively. The numbers 1 though 29 are assigned along the frequency axis. These numbers show the numbers of subcarriers. As described above, the subchannels are configured by multicarrier signals and particularly by OFDM signals. The expression “TS” in the figure represents a training symbol and is composed of a well-known value. The expression “GS” represents a guard symbol, and no substantial signal is placed in the guard symbol. The expression “PS” represents a pilot symbol and is composed of a well-known value. The expression “DS” represents a data symbol and is data to be transmitted. The expression “GT” represents guard time, and no substantial signal is placed during the guard time. As shown in the figure, the subchannels constitute a packet signal.

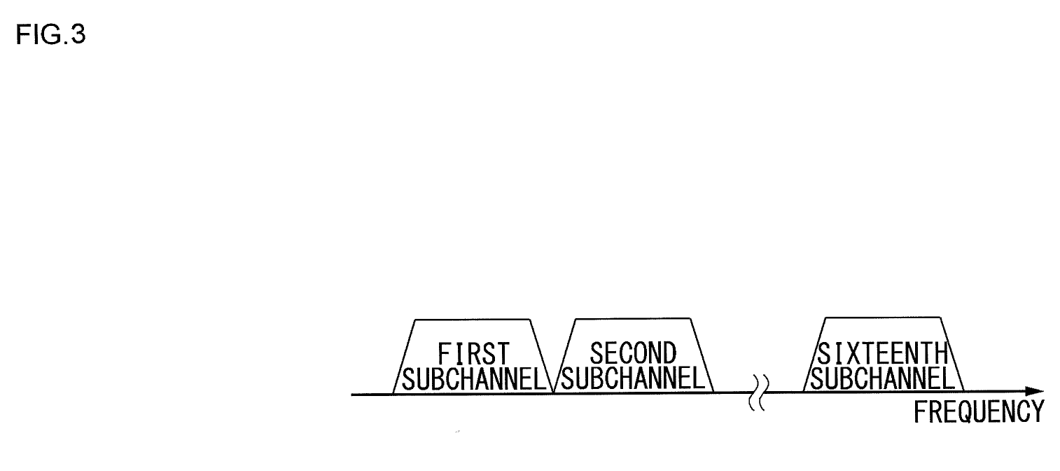

FIG. 3 illustrates the arrangement of subchannels in a communication system 100. FIG. 3 shows a frequency axis on a horizontal plane and shows a spectrum for the time slot shown in FIG. 2B. As previously described, one time slot is formed by the frequency division multiplexing of 16 subchannels, from the first subchannel to the sixteenth subchannel. Each subchannel is configured by a multicarrier signal, in this case, by an OFDM signal.

FIG. 1 is referred back. The modulator 12 modulates a signal to be transmitted. The signal to be transmitted corresponds to the downlink time slot of FIG. 2A and is configured as shown in FIGS. 2B and 2C. A few or many of the plurality of subchannels shown in FIG. 2B may be used. For example, one subchannel is used as the former case, and 16 subchannels are used as the latter case. The former corresponds to the first case, and the latter corresponds to the second case. A plurality of subcarriers are included in a subchannel that is used, and the modulator 12 performs a modulation process, in parallel, on the plurality of subchannels included in the subchannel that is used. A signal modulated by the modulator 12 corresponds to an OFDM signal in the frequency domain. The modulator 12 outputs an OFDM signal in the frequency domain to an IFFT unit 14.

The IFFT unit 14 receives from the modulator 12 an OFDM signal in the frequency domain. The IFFT unit 14 converts the OFDM signal from the frequency domain to the time domain by performing an IFFT on the OFDM signal. The size of the amplitude of the OFDM signal depends on the number of subchannels that are being used, that is, the number of subcarriers. In other words, the larger the number of subchannels that are used becomes, the larger the amplitude of the OFDM signal becomes. Thus, the amplitude of the OFDM signal is larger in the second case than in the first case. The IFFT unit 14 outputs an OFDM signal in the time domain to an RF unit 16.

The RF unit 16 receives from the IFFT unit 14 the OFDM signal in the time domain. The RF unit 16 generates, by performing quadrature-modulation on the OFDM signal, an OFDM signal of an intermediate frequency and further converts the frequency of the OFDM signal from an intermediate frequency to a radio frequency. The RF unit 16 is provided with an amplifier (not shown) and amplifies the OFDM signal by an amplifier. The RF unit 16 transmits from an antenna 18 for a base station the OFDM signal of a radio frequency.

An antenna 22 for a terminal receives from the antenna 18 for a base station the OFDM signal and outputs the OFDM signal to a frequency-converting unit 24. The frequency-converting unit 24 receives from the antenna 22 for a terminal the OFDM signal of a radio frequency and converts the frequency of the OFDM signal from a radio frequency to an intermediate frequency. The frequency-converting unit 24 generates an OFDM signal of a baseband by quadrature detection. An AGC 26 receives the OFDM signal from the antenna 22 for a terminal and amplifies the amplitude of the OFDM signal so that the amplitude of the OFDM signal will be within the dynamic range of a subsequent A/D unit 28. Thus, as long as the operation of the AGC 26 is performed in an ideal manner, the amplitude of the OFDM signal that is output from the AGC 26 becomes constant regardless of whether it is the first case or the second case.

The A/D unit 28 generates an OFDM signal as a digital signal by analog-to-digital conversion of the OFDM signal amplified by the AGC 26. The filter unit 30 reduces the noise component included in the OFDM signal from the A/D unit 28. A FFT unit 32 receives from the filter unit 30 the OFDM signal. The FFT unit 32 converts the OFDM signal from the time domain to the frequency domain by performing an FFT on the OFDM signal. The FFT unit 32 carries out an FFT by floating-point arithmetic. Thus, the OFDM signal in a frequency domain is shown as a floating-point number. The size of the amplitude of the OFDM signal in the time domain is almost constant. Thus, the larger the number of subchannels that are being used, that is, the number of subcarriers, the smaller the amplitude of the OFDM signal becomes. Thus, the amplitude of the OFDM signal is smaller in the second case than in the first case. The FFT unit 32 outputs the OFDM signal in the frequency domain to a bit-converting unit 34.

The bit converting unit 34 receives from the FFT unit 32 the OFDM signal in the frequency domain. The bit-converting unit 34 generates an OFDM signal of a fixed-point number by converting the OFDM signal in the frequency domain from a floating-point number to a fixed-point number. When changing from the floating-point number to the fixed-point number, a bit width that corresponds to the part to be extracted as the fixed-point number is set at a predetermined bit position. The setting will be hereinafter described. The bit-converting unit 34 outputs the converted OFDM signal. An IQ shift unit 36 performs a bit shift on the OFDM signal from the bit-converting unit 34. The bit shift will be described in detail hereinafter.

A reception processor 38 receives from the IQ shift unit 36 the OFDM signal and performs a reception process such as demodulation. The reception process includes de-interleaving and decoding, and the de-interleaving and decoding are defined so as to correspond to the interleaving and error correction encoding performed by the base station apparatus 10. For example, convolutional coding is used as the error correction encoding. The OFDM signal received from the IQ shift unit 36 is a fixed-point number. Thus, the reception processor 38 performs fixed-point arithmetic. The OFDM signal is composed of a plurality of subcarriers, and common fixed-point numbers are defined throughout the plurality of subcarriers. The control unit 40 controls the overall timing, etc., of the terminal apparatus 20.

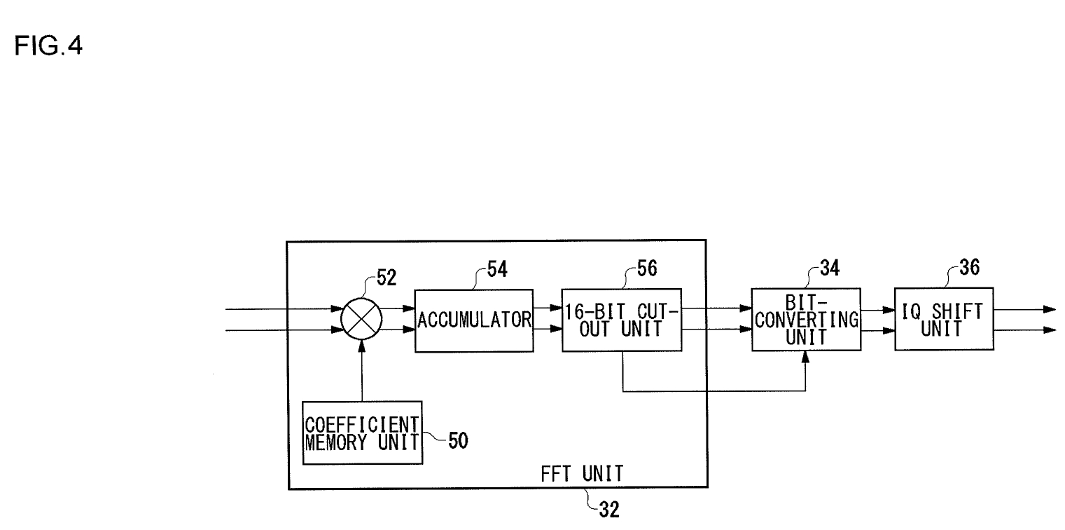

FIG. 4 illustrates the configurations of an FFT unit 32, a bit-converting unit 34, and an IQ shift unit 36. The FFT unit 32 includes a coefficient memory unit 50, a multiplier 52, an accumulator 54, and a 16-bit cut-out unit 56. The coefficient memory unit 50 stores a coefficient for FFT, the multiplier 52 performs the multiplication of an OFDM signal in the time domain with the coefficient, and the accumulator 54 accumulates the multiplication results. In other words, the coefficient memory unit 50, the multiplier 52, and the accumulator 54 perform an FFT. The FFT is performed by floating-point arithmetic. For example, the accumulator 54 outputs, as the result of the FFT, the value of 48-bit floating-point number for each subcarrier.

The 16-bit cut-out unit 56 receives the result of the FFT from the accumulator 54. As previously described, the result of the FFT includes values that correspond to the plurality of subcarriers, respectively. For one subcarrier, the 16-bit cut-out unit 56 specifies the position, in a 48-bit floating-point number, of the highest-order bit including an effective value. The effective value correspond to, for example, the value of the 21st bit and subsequent bits when the values of the first 20 bits are “0” and when the value of “1” appears at the 21st and subsequent bits of the 48 bits. In other words, the effective value is the value of the part having a substantial value as a point number. The 16-bit cut-out unit 56 extracts the value of 16 bits starting from the highest-order bit. The 16-bit cut-out unit 56 performs a similar process on another subcarrier and outputs to the bit-converting unit 34 both the floating-point number of 16 bits for all the subcarriers and the positional information of the highest-order bit for all the subcarriers.

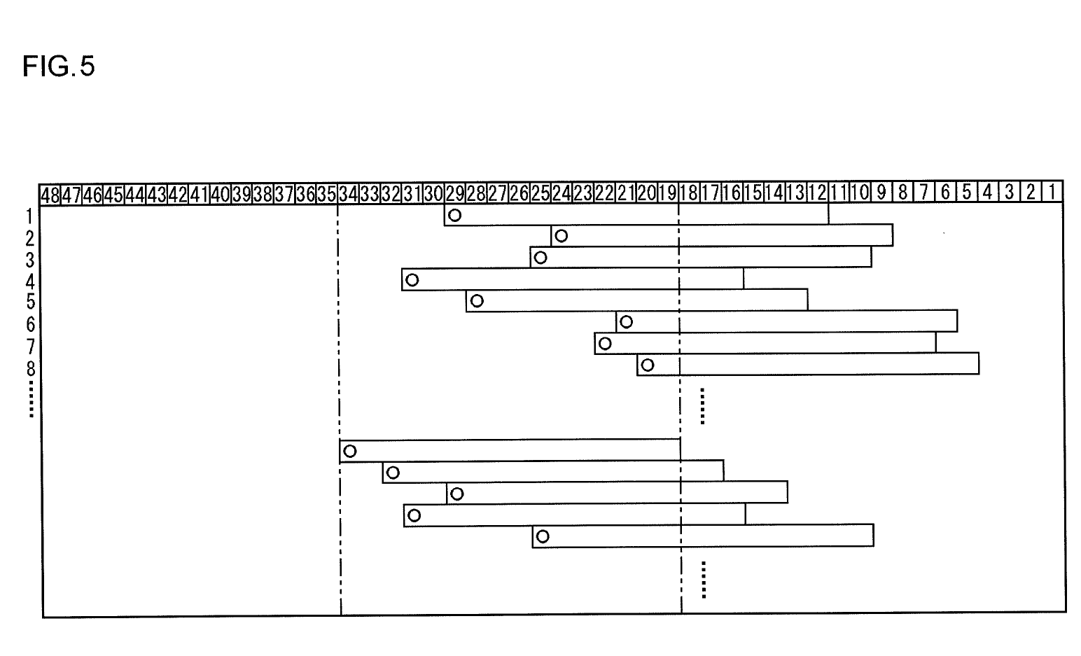

FIG. 5 illustrates the overview of the processes of the FFT unit 32 and the bit-converting unit 34. Shown at the top are the values of the 48 bits output by the accumulator 54. Bit values of the 48th bit through the 1st bit are lined from left to right in the figure. The bit value shown as “48” corresponds to the MSB and the bit value shown as “1” corresponds to the LSB. The values of 16 bits extracted by the 16-bit cut-out unit 56 are shown below the values of the 48 bits. The numbers shown from the top to the bottom as “1”, “2”, and “3” are subcarrier numbers. For example, the position of the highest-order bit including an effective value corresponds to the 27th bit for the subcarrier number “1”. The position of the highest-order bit is indicated by a circle. The 16-bit cut-out unit 56 extracts the 27th bit through the 12th bit. A similar process is performed on other subcarriers. The position of the highest-order bit varies for each subcarrier.

FIG. 4 is referred back. The bit-converting unit 34 receives an OFDM signal that has been converted into the frequency domain and that is also a multicarrier signal shown as a floating-point number. The bit-converting unit 34 receives, from the 16-bit cut-out unit 56, the 16-bit floating-point number for each subcarrier and also receives the positional information of the highest-order bit for each subcarrier. The bit converting unit 34 specifies the position of the highest-order bit for each of the plurality of subcarriers based on the positional information of the highest-order bit. In the case of FIG. 5, the bit-converting unit 34 specifies the 27th subcarrier for the subcarrier number “1” and the 24th subcarrier for the subcarrier number “2”. The bit-converting unit 34 determines the position of the bit width to be commonly used for each of the plurality of subcarriers based on the specified positions of the highest-order bits. More specifically, the bit-converting unit 34 specifies the bit position of the highest value among the respective positions of the highest-order bits of the plurality of subcarriers and sets the bit width to the 16 bits starting from the bit with the specified value.

In the case of FIG. 5, the bit-converting unit 34 specifies the position of the 34th bit to have the highest value and sets the bit width to the 34th through 19th bits. In consideration of the margin, not the bit position of the highest value but the position of a bit whose bit number is higher by a few bits than the bit of the highest value bit may be specified. The number of subchannels that are used generally varies for each time slot. Thus, the bit-converting unit 34 determines the position of the bit width for each time slot. As shown in FIG. 2C, a “TS” is placed at the front part of one burst, and a “DS” is subsequently placed. The above-described process for determining the position of the bit width is performed during the period of the TS. Meanwhile, the burst that starts from the TS is separately stored in the bit-converting unit 34. After the determination of the position of the bit width, the bit-converting unit 34 performs the conversion from a floating-point number to a fixed-point number while using the determined position of the bit width. Publicly-known techniques need to be used for the conversion, and the explanation thereof is thus omitted. The fixed-point number as converted also has a 16-bit value. The bit-converting unit 34 outputs the value of the fixed-point number as converted to the IQ shift unit 36.

When the bit-converting unit 34 specifies the position of a bit whose bit number is higher by a few bits than the highest-order bit of the subcarriers, the IQ shift unit 36 performs a bit shift on the respective fixed-point numbers, depending on the respective positions of the highest bits of the plurality of subcarriers. Comparing the respective values of the positions of the highest-order bits of the plurality of subcarriers with a first threshold value, the IQ shift unit 36 performs, when the number of the positions of the bits whose values are smaller than the first threshold value is larger than a second threshold value, a bit shift so that the number of bit positions that are smaller than the first threshold value does not exceed the second threshold value. In other words, the IQ shift unit 36 inserts 0's into the LSB side. The IQ shift unit 36 determines for both an in-phase component and an orthogonal component whether the number of the positions of the bits whose values are smaller than the first threshold value is larger than the second threshold value and performs bit shift when the number of bit positions that are smaller than the first threshold value is determined, for the both components, to be larger than the second threshold value. Thus, the amount of bit shifting for the in-phase component and the amount of bit shifting for the quadrature component become the same. Even with such a bit shift, the effective bit accuracy does not change; however, the effective bit number increases. Thus, the occurrence of underflow in the subsequent reception processor can be suppressed.

An explanation is given of the operation of the communication system 100 having the above-stated configuration. The base station apparatus 10 stores data in a subchannel allocated to the terminal apparatus 20 and generates an OFDM signal in the time domain by performing an IFFT on at least one subchannel. The base station apparatus 10 transmits the OFDM signal in the time domain. The terminal apparatus 20 receives the OFDM signal in the time domain, and the coefficient memory unit 50 and the accumulator 54 convert the OFDM signal in the time domain into an OFDM signal in the frequency domain by performing an FFT. As a result, an OFDM signal in the frequency domain is generated as a 48-bit floating-point number. For each subcarrier, the 16-bit cut-out unit 56 specifies the position, in the 48-bit floating-point number, of the highest-order bit including an effective value.

The 16-bit cut-out unit 56 extracts the value of 16 bits including the bit at the specified bit position and the subsequent lower bits thereof. As a result, the 16-bit cut-out unit 56 converts the 48-bit floating-point number into a 16-bit floating-point number. During the period of TS, the bit-converting unit 34 specifies the bit position of the highest value among the respective positions of the highest-order bits of the plurality of subcarriers and determines the position of the bit width based on the specified value. The bit-converting unit 34 converts the 16-bit floating-point number into a 16-bit fixed-point number while using the determined position of the bit width throughout the burst. The IQ shift unit 36 performs a bit shift on the 16-bit fixed-point number as necessary. The reception processor 38 receives the OFDM signal in the frequency domain shown by a 16-bit fixed-point number.

According to the embodiment of the present invention, the position of a bit width is determined based on the position of the highest-order bit, and the position of the bit width can thus be adjusted, when performing the conversion of an OFDM signal from a floating-point number into a fixed-point number, in accordance with the value of the signal. Adjusting the position of the bit width in accordance with the value of the signal allows for the reduction of the probability of underflow or overflow to occur during subsequent fixed-point arithmetic. The reduction of the probability of underflow or overflow to occur allows for the receiving characteristic to be improved. The subsequent fixed-point arithmetic allows for the reduction of the throughput.

Specifying the highest value among the values of the positions of the highest-order bits and determining the position of a bit width based on the specified value allow for the position of the bit width to be determined with reference to a high-reliability value among a plurality of subcarriers. The determination of the position of the bit width with reference to the highly-reliable value allows for the receiving characteristic to be improved. There is a case where a low-reliability value is excluded from the bit width; however, interleaving and error correction allow for deterioration in reception quality to be suppressed. Since the position of the bit width is determined in consideration of a margin, the probability of overflow to occur can be reduced.

Described above is an explanation based on the embodiments of the present invention. These embodiments are intended to be illustrative only, and it will be obvious to those skilled in the art that various modifications to constituting elements and processes could be developed and that such modifications are also within the scope of the present invention.

According to the embodiment of the present invention, the bit-converting unit 34 specifies the highest value among the values of the respective highest-order bits of a plurality of subcarriers and determines the position of a bit width based on the specified value. A predetermined margin may be added to the specified value. However, the embodiment is not limited to this example. For example, the bit-converting unit 34 may determine the position of a bit width also in consideration of subcarriers other than the subcarrier in which the bit of the specified highest value is placed. In other words, the bit-converting unit 34 temporarily determines the position of the bit width based on one of the specified positions of the highest-order bits. The bit-converting unit 34 shifts the position of the bit width from the temporary position of the bit width while incorporating the positions of the remaining highest-order bits. When the number of the positions of the remaining highest-order bits that are not included in the bit width is larger than a third threshold value, the bit-converting unit 34 shifts the bit width toward the LSB so that the number is equal to the third threshold value or less. According to the exemplary variations, the number of subcarriers included in a bit width increases, and the receiving characteristic can thus be improved.

### INDUSTRIAL APPLICABILITY

According to the present invention, the position of a bit width can be adjusted when performing the conversion of a multicarrier signal from a floating-point number into a fixed-point number, in accordance with the value of the signal.

1. A converter comprising:
an input unit operative to input a multicarrier signal that has been converted into the frequency domain and that is also a multicarrier signal shown as a floating-point number;
a converting unit operative to perform conversion from a floating-point number to a fixed-point number on the multicarrier signal input by the input unit; and
an output unit operative to output the multicarrier signal converted by the converting unit to a signal processor that performs fixed-point arithmetic, wherein
the converting unit includes:
a specification unit operative to specify the position of the highest-order bit for each of the plurality of subcarriers that form the multicarrier signal;
a determination unit operative to determine the position of a bit width to be commonly used for each of the plurality of subcarriers based on the position of the highest-order bit specified by the specification unit; and
a processing unit operative to convert the multicarrier signal while using the position of the bit width determined by the determination unit.

2. The converter according to claim 1 wherein the determination unit includes: a means for temporarily determining the position of the bit width based on one of the positions of the highest-order bits specified by the specification unit; and a means for shifting the position of the bit width from the temporary position of the bit width while incorporating the positions of the remaining highest-order bits.
